(19) United States
(12) Patent Application Publication
(10) Pub. No.: US 2010/0248129 A1
(43) Pub. Date: Sep. 30, 2010

(54) IMAGE FORMING APPARATUS AND IMAGE FORMING METHOD

(75) Inventors: Masahiro MAEDA, Matsumoto-shi (JP); Yoichi YAMADA, Shiojiri-shi (JP); Masaru KOBASHI, Matsumoto-shi (JP); Tomohiro ARUGA, Matsumoto-shi (JP); Takatomo FUKUMOTO, Shiojiri-shi (JP); Atsunori KITAZAWA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/727,310

(22) Filed: Mar. 19, 2010

(30) Foreign Application Priority Data
Mar. 26, 2009 (JP) 2009-077268

(51) Int. Cl. G03G 21/00; G03G 15/02

(52) U.S. Cl. 430/119.82; 399/350; 399/50

(57) ABSTRACT

An image forming apparatus includes: a latent image carrier which circumferentially rotates in a predetermined rotational direction; a conductive blade which cleans a surface of the latent image carrier by being in contact with the surface of the latent image carrier, and charges the surface of the latent image carrier at a first electric potential having the same polarity as normal charged polarity of a toner according to application of direct current voltage having the same polarity as the normal charged polarity of the toner, in a predetermined cleaning and charging position; and a charger which provides electric charge having reverse polarity to the normal charged polarity and adjusts an electric potential of the surface of the latent image carrier to a second electric potential, in a secondary charging position located on a downstream side of the cleaning and charging position in the rotational direction.

### BACKGROUND

1. Technical Field

The present invention relates to an image forming apparatus and an image forming method in which a toner image is formed by developing an electrostatic latent image formed on a surface of a latent image carrier using a toner, and more specifically, to cleaning and charging the surface of the latent image carrier.

2. Related Art

In an electro-photographic image forming apparatus such as an electrostatic copier, a printer or a facsimile, a surface of a latent image carrier such as a photosensitive drum or a photosensitive belt is uniformly charged, and then an electrostatic latent image is formed on the surface of the corresponding latent image carrier. Further, the electrostatic latent image is developed by a charging toner. Then, the toner image formed on the surface of the latent image carrier is transferred via an intermediate transfer member disposed in a predetermined transfer position, or directly, onto a transfer member such as a printing paper, and then, is fixed on the transfer member by a fixing unit.

In the image forming apparatus in the related art, in order to uniformly and desirably charge the surface of the latent image carrier, two stages of charging processes are performed as disclosed in, for example, JP-A-2005-215321 (FIG. 1). In the image forming apparatus disclosed in the JP-A-2005-215321 (FIG. 1), a charging brush as a first charging member is in contact with the surface of the latent image carrier to primarily charge the surface of the latent image carrier, and then, a conductive roller (charging roller) located on a downstream side of the charging brush is in contact with the surface of the latent image carrier to secondarily charge the surface of the latent image carrier in a rotational direction of the latent image carrier, and thus, charging irregularities which may be generated when the surface of the latent image carrier is charged with the charging brush are removed, thereby uniformly charging the surface of the latent image carrier.

However, since efficiency of the transfer from the latent image carrier to the intermediate transfer member or the transfer member is 100% or less, a small amount of toner may remain on the surface of the latent image carrier after transfer. In such an image forming apparatus, it is necessary to clean and remove the remaining transfer toner from the surface of the latent image carrier on a downstream side of the transfer position in the rotational direction of the latent image carrier. Accordingly, in view of the miniaturization of the apparatus, the primary charging process and the cleaning process may be simultaneously performed by the charging brush.

However, in the related art apparatus, in order to charge the surface of the latent image carrier at a predetermined electric potential by the charging brush, a charging bias exceeding discharging starting voltage for the latent image carrier needs to be applied to the charging brush. Thus, the remaining transfer toner cannot be cleaning-removed by the charging brush. Accordingly, as disclosed in the JP-A-2005-215321 (FIG. 1), in the related art apparatus which performs the two stages of the charging processes, it is necessary to provide a separate cleaning unit in addition to the charging unit such as a charging brush or charging roller. As a result, there is a problem that the apparatus inevitably becomes larger.

### SUMMARY

An advantage of some aspects of the invention is that it provides an image forming apparatus and an image forming method in which a charging process and a cleaning process on a surface of a latent image carrier can be desirably performed with a small number of components.

According to an aspect of the invention, there is provided an image forming apparatus including: a latent image carrier which circumferentially rotates in a predetermined rotational direction; a conductive blade which cleans a surface of the latent image carrier by being in contact with the surface of the latent image carrier, and charges the surface of the latent image carrier at a first electric potential having the same polarity as normal charged polarity of a toner according to application of direct current voltage having the same polarity as the normal charged polarity of the toner, in a predetermined cleaning and charging position; and a charger which provides an electric charge having reverse polarity to the normal charged polarity and adjusts an electric potential of the surface of the latent image carrier to a second electric potential, in a secondary charging position located on a downstream side of the cleaning and charging position in the rotational direction.

According to another aspect of the invention, there is provided an image forming method including: cleaning a surface of a latent image carrier which circumferentially rotates in a predetermined rotational direction by bring a conductive blade into contact with the surface of the latent image carrier, and charging the surface of the latent image carrier at a first electric potential having the same polarity as normal charged polarity of a toner according to application of direct current voltage having the same polarity as the normal charged polarity of the toner to the conductive blade; and providing an electric charge having reverse polarity to the normal charged polarity for the surface of the latent image carrier which is charged at the first electric potential, and adjusting the electric potential of the surface of the latent image carrier to a second electric potential.

In the image forming apparatus and the image forming method with such a configuration, the cleaning on the surface of the latent image carrier is performed by the conductive blade which is in contact with the surface of the latent image carrier in the cleaning and charging position. Further, at the same time, the surface of the latent image carrier is primarily charged at the first electric potential by the conductive blade, and then, the electric potential of the surface of the latent image carrier is adjusted to the second electric potential in the secondary charging position. That is, the conductive blade has a primary charging function and a cleaning function, and thus, the charging process and the cleaning process can be performed with a small number of components.

Further, the direct current voltage having the same polarity as the normal charged polarity of the toner is applied to the conductive blade, and thus, the primary charging and the cleaning can be desirably performed while preventing deterioration of the latent image carrier or an error of the cleaning. The reasons are as follows: That is, in the related art, there is proposed a technology in which a so-called overlap bias generated by overlapping alternating current voltage and direct current voltage is applied to a conductive member in order to perform a cleaning process using the conductive member such as a conductive blade or a conductive sponge and to complete the charging process during the corresponding cleaning process. However, in the case of such a related art, polarity or an electrical potential difference between the surface of the latent image carrier and the conductive member rapidly varies. Further, due to the deterioration of the latent image carrier, there occur problems such as film thinning or cleaning deterioration. In addition, cleaning errors are generated by vibrations. However, in the invention, the direct current voltage having the same polarity as the positive normal charged polarity of the toner is provided to the conductive blade, and thus, the surface of the latent image carrier can be desirably cleaned and can be primarily charged without the above described problems. Further, the secondary charging is performed by the charger for the surface of the latent image carrier which is primarily charged, and thus, the surface of the latent image carrier is uniformly adjusted to a desirable electric potential to complete the charging process.

As described above, the invention combines the configuration in which the conductive blade is used as one stage charging unit for two stages of charging processes with the configuration in which the direct current voltage having the same polarity as the positive charged polarity of the toner is applied to the corresponding conductive blade, and thus, the charging process and the cleaning process of the surface of the latent image carrier can be desirably performed with a small number of components.

Herein, the direct current voltage to be applied to the conductive blade may be constant-voltage-controlled. In this case, a so-called neutralization-free configuration in which a neutralization unit is not installed between the transfer position in which the toner image is transferred to the transfer medium and the cleaning and charging position may be employed, thereby achieving miniaturization of the apparatus. Further, in such a neutralization-free configuration, the surface of the latent image carrier reaches the cleaning and charging position in a non-neutralized state after passing through the transfer position. Herein, a surface electric potential in a so-called non-exposure region among the surface of the latent image carrier is adjusted to the second electric potential by a previously performed secondary charging process. Thus, the electric potential difference between the corresponding non-exposure region and the conductive blade is small and current flowing therebetween (blade current) is small. Thus, deterioration of the latent image carrier or deterioration of the conductive blade can be prevented, thereby achieving a long life apparatus. In addition, according to the aging of the conductive blade, the electric potential difference between the conductive blade and the surface of the latent image carrier is increased, and thus, the blade current flowing between the conductive blade and the surface of the latent image carrier can be constantly optimized, thereby desirably charging the surface of the latent image carrier.

Moreover, instead of the above described constant voltage control, a constant current control may be performed. In this case, it is desirable that a neutralization unit is installed between the transfer position and the cleaning and charging position. That is, in the case that a neutralization process is not performed, the surface electric potential of the non-exposure region is the second electric potential as described above, but in the constant current control, a predetermined current also flows between the corresponding non-exposure region and the conductive blade, and thus, the non-exposure region becomes an overcharged state. However, the neutralization process may be performed for the surface of the latent image carrier before reaching the cleaning and charging position, thereby preventing the overcharging, and constantly and appropriately primarily charging the surface of the latent image carrier.

Further, the electrostatic latent image is formed on the surface of the latent image charier which is charged as described above, and is developed by the developing unit to form the toner image. In this respect, the corresponding developing unit may provide the toner onto the surface of the latent image carrier from the toner carrier which is arranged opposite to the latent image carrier in a non-contact manner to form the electrostatic latent image. That is, if an additive detached from the toner is adhere to the toner carrier and then the additive is scattered from the toner carrier to adhere to the latent image carrier, it is difficult to appropriately charge the surface of the latent image carrier, thereby causing deterioration of image quality. Herein, in a non-contact developing method, since the toner carrier is spaced from the latent image carrier, it is difficult for the additive which is detached from the toner and is adhered to the toner carrier to be scattered to the latent image carrier, and thus, the above problems can be prevented. Further, if the toner carrier is formed of metal, an image force of the additive for the toner carrier becomes large, and the scattering of the additive to the latent image carrier can be more effectively prevented.

### BRIEF DESCRIPTION OF THE DRAWINGS

The invention will be described with reference to the accompanying drawings, wherein like numbers reference like elements.

FIG. 1 schematically illustrates a main configuration of an embodiment of an image forming apparatus according to the invention.

FIG. 2 is a block diagram illustrating an electric configuration of the apparatus in FIG. 1.

FIG. 3 illustrates a relation between blade applied voltage and blade current of the apparatus in FIG. 1.

### DESCRIPTION OF EXEMPLARY EMBODIMENTS

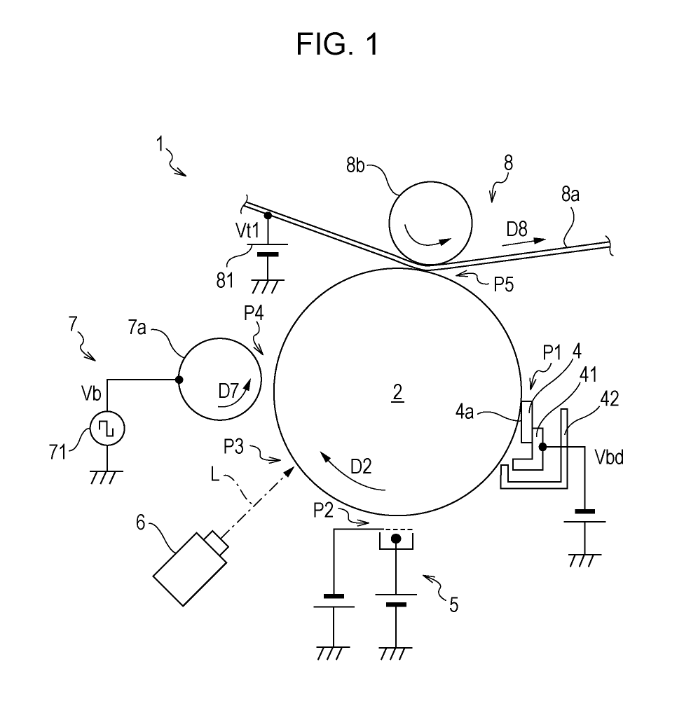

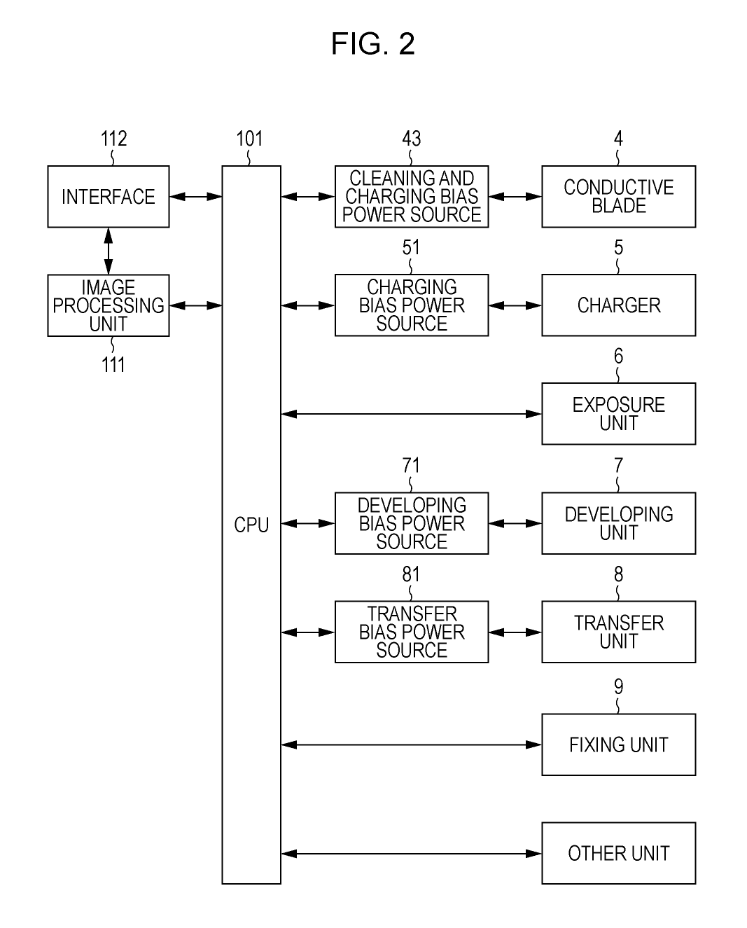

FIG. 1 schematically illustrates a main configuration of an embodiment of an image forming apparatus according to the invention. FIG. 2 is a block diagram illustrating an electric configuration of the apparatus in FIG. 1. In the image forming apparatus 1, an image is formed using a nonmagnetic one-component system negative charged toner. That is, in this embodiment, negative polarity is “normal charged polarity”. Alternatively, the image may be formed using a positive charged toner in which positive polarity is the normal charged polarity. Hereinafter, it is assumed that the image forming apparatus 1 uses a negative charged toner. However, in the case that the positive charged toner is used, a charging electric potential of each member to be described below may be set to reverse polarity. Herein, the toner includes a toner mother particle and an additive which is added to the toner mother particle, but in the following description, “toner” refers to all the particles made by adding the additive to the toner mother particle.

As shown in FIG. 1, the image forming apparatus 1 includes a photosensitive body 2 onto which an electrostatic latent image and a toner image are formed. The photosensitive body 2 is made of a photosensitive drum, and includes a cylindrical metal tube on a circumferential surface of which a photosensitive layer having a predetermined film thickness is formed, like a photosensitive drum which is known in the related art. For example, a conductive tube such as aluminum, etc. is used as the metal tube in the photosensitive body 2, and an organic photosensitive body which is known in the related art is used as the photosensitive layer. In such an embodiment, the photosensitive body 2 corresponds to a “latent image carrier” in the invention.

Around the photosensitive body 2, a conductive blade 4 which has a cleaning function and a primary charging function, a charger 5 which adjusts an electric potential of a surface of the photosensitive body 2 at a predetermined electric potential by performing a secondary charging process for the surface of the photosensitive body 2 which is primarily charged by the conductive blade 4, an exposure unit 6 which forms the electrostatic latent image by exposing the surface of the photosensitive body 2 according to an image signal, a developing unit 7 which develops the electrostatic latent image as a toner image, and a transfer unit 8 in which toner image is transferred are sequentially arranged in a rotational direction D2 (clockwise in FIG. 1) of the photosensitive body 2, respectively. Hereinafter, a position in which the conductive blade 4 and the surface of the photosensitive body 2 are in contact with each other to perform a cleaning and a primary charging is defined as a cleaning and charging position P1; a position in which a secondary charging is performed by the charger 5 is defined as a secondary charging position P2; a position in which a light beam L is illuminated from the exposure unit 6 to the surface of the photosensitive body 2 is defined as an exposure position P3; a position in which a developing roller 7a of the developing unit 7 is opposite to the photosensitive body 2 is defined as a development position P4; and a position in which the photosensitive body 2 is in contact with an intermediate transfer belt 8a is defined as a transfer position P5. In this embodiment, the respective positions are arranged in the above described order, from an upstream side of the rotational direction D2 of the photosensitive body 2 to a downstream side thereof.

In this embodiment, the surface of the photosensitive body 2 is primarily charged by the conductive blade 4, and then, is secondarily charged by the charger 5, thereby uniformly charging the surface of the photosensitive body 2 at a desirable electric potential. Configurations and operations of the conductive blade 4 and the charger 5 will be described later, which includes a cleaning operation of remaining transfer toner.

On the surface of the photosensitive body 2 which is charged as described above, the electrostatic latent image is formed by the exposure unit 6. The exposure unit 6 exposes the surface of the photosensitive body 2 by the light beam L according to an image signal which is provided from an external apparatus, to form an electrostatic latent image corresponding to the image signal. More specifically, as shown in FIG. 2, if the image signal is supplied through an interface 112 from the external apparatus such as a host computer which generates the image signal, a predetermined process is performed for the image signal by an image processing unit 111. The image signal is transmitted to the exposure unit 6 through a CPU 101 which controls the overall operation of the apparatus. The exposure unit 6 illuminates the light beam L on the surface of the photosensitive body 2 for exposing according to the image signal. A surface region of the photosensitive body 2 which is exposed (exposure region) is electrically neutralized, and is changed into a surface electric potential which is different from that of a surface region which is not exposed (non-exposure region). Thus, the electrostatic latent image corresponding to the image signal is formed on the photosensitive body 2. In this embodiment, the exposure unit 6 corresponds to a “latent image forming unit” in the invention.

A toner is supplied to the above described formed electrostatic latent image from the developing unit 7 and the electrostatic latent image is developed by the toner. The developing unit 7 of such an image forming apparatus 1 has a non-contact developing method in which the developing roller 7a is not in contact with the photosensitive body 2. The developing roller 7a is opposed to the photosensitive body 2 with a predetermined gap, for example, 100 μm or more, and is rotated in an arrow direction D7 in FIG. 1. A predetermined developing bias Vb is applied to the developing roller 7a from a developing bias power source 71. In such an embodiment, the developing roller 7a corresponds to a “toner carrier” in the invention.

Further, the transfer unit 8 includes the intermediate transfer belt 8a which is an endless belt capable of carrying the toner image on a surface thereof and circumferentially rotates in an arrow direction D8 in FIG. 1. The intermediate transfer belt 8a is brought in contact with the surface of the photosensitive body 2 by a back up roller 8b which is arranged adjacent to the photosensitive body 2. In addition, a transfer bias Vt1 having reverse polarity to the charged polarity of the toner is applied to the intermediate transfer belt 8a from a transfer bias power source 81, and thus, the toner image which is developed on the photosensitive body 2 is transferred to the intermediate transfer belt 8a (primary transfer). The toner image which is transferred to the intermediate transfer belt 8a is secondarily transferred onto a recording paper (not shown) and permanently fixed on the recording paper by a fixing unit 9 for output.

In the rotational direction D2 of the photosensitive body 2, the conductive blade 4 is arranged in the cleaning and charging position P1 located on a downstream side of the transfer position P5. The conductive blade 4 may use rubber, resin or the like having a conductive characteristic to perform the cleaning process of the photosensitive body 2 as in the related art. Moreover, in this embodiment, the conductive blade 4 has a plate shape which is extended in a width direction (direction perpendicular to a plane of FIG. 1), and the length of the width direction is slightly longer than the width of an image forming region of the photosensitive body 2. For example, if the length of the width direction of the image forming region is 291 mm, the length of the width direction of the conductive blade 4 may be set to 310 mm.

A rear end part of the conductive blade 4 is supported by a support member 41 which is formed of metal material (including alloy) such as stainless steel, iron, copper, aluminum, aluminum alloy, nickel or phosphor bronze, or material having a conductive characteristic obtained by depositing conductive metal such as aluminum to conductive resin or resin, etc. Meanwhile, the front end part of the conductive blade 4 protrudes from the front end of the support member 41 and is in contact with the surface of the photosensitive body 2 in the cleaning and charging position P1. In this embodiment, the front end part of the conductive blade 4 is in contact with the photosensitive body 2 in the reverse direction to the rotational direction D2 of the photosensitive body 2, and a contact angle (inclined angle of the conductive blade 4 in a tangential direction to the surface of the photosensitive body 2 in the cleaning and charging position P1) of the conductive blade 4 is set to about 10°. Further, in this embodiment, the weight of the conductive blade 4 against the photosensitive body 2 is set to 13 g/cm. Under such a cleaning condition, the remaining toner on the surface of the photosensitive body 2 is scraped by the conductive blade 4, thereby to be cleaning-removed from the surface of the photosensitive body 2. The scraped toner is collected in a toner collecting box 42 which is arranged in a position downward from the conductive blade 4 and the support member 41.

In addition, a cleaning and charging bias power source 43 is electrically connected to the conductive blade 4, and a cleaning and charging bias Vbd having negative direct current (DC) is applied to the conductive blade 4. Thus, the surface of the photosensitive body 2 is charged at a negative electric potential. For example, if the cleaning and charging bias Vbd having the direct current of −1.4 kV is applied to a newly installed conductive blade 4, the surface electric potential of the photosensitive body 2 in the cleaning and charging position P1 may be charged at −600 V. That is, since a relation between the cleaning and charging bias Vbd and the surface electric potential (corresponding to “a first electric potential” in the invention) of the photosensitive body 2 in the cleaning and charging position P1 is varied according to the aging of the conductive blade 4, in this embodiment, a value of the cleaning and charging bias Vbd may be varied according to the aging of the conductive blade 4 as described later.

Since the surface electric potential of the photosensitive body 2 which is primarily charged as described above is uniformized, and the corresponding surface electric potential is secondarily charged at an electric potential (corresponding to “a second electric potential” in the invention) suitable for image forming, the charger 5 is installed in the secondary charging position P2 located on a downstream side of the cleaning and charging position P1, in the rotational direction D2 of the photosensitive body 2. In this embodiment, the charger 5 may employ a scorotron charger 5 which is well known in the related art, which is not in contact with the surface of the photosensitive body 2. The scorotron charger 5 is electrically connected to a charging bias power source 51. A positive wire-current Iw flows to a charge wire 5b of the scorotron charger 5, and a grid charging bias Vg having negative direct current (DC) is applied to a grid 5a. Accordingly, an electric charge having the reverse polarity (positive polarity) to the toner is provided to the photosensitive body 2 by the charger 5, and thus, the surface electric potential of the photosensitive body 2 becomes approximately uniform. Moreover, the surface electric potential of the photosensitive body 2 is adjusted to the second electric potential from the first electric potential, more specifically, to the surface electric potential which is set during the image forming. For example, if the direct current voltage of +4 kV is applied to the charge wire 5b which is gold-coated to flow the wire current Iw of +400 μA and direct current voltage of −500 V is applied to the grid 5a, the surface electric potential of the photosensitive body 2 which is charged at −600 V by the primary charging is uniformly adjusted to approximately −500 V.

The above described exposure process and developing process are sequentially performed for the surface of the photosensitive body 2 which is charged at a desired second electric potential to form the toner image, and then, the toner image is transferred to the intermediate transfer belt (transfer medium) 8a by the transfer unit 8.

However, in this embodiment, the cleaning and charging bias power source 43 constant-voltage-controls the direct current voltage applied to the conductive blade 4 according to an operation command from the CPU 101, and thus, a so-called neutralization-free configuration, in which a neutralization unit is not installed, is employed. That is, in the embodiment, the surface region of the photosensitive body 2 which has passed through the transfer position P5 is configured to reach the cleaning and charging position P1 in a non-neutralized state. Accordingly, in the case that the corresponding surface region is the non-exposure region, the corresponding surface region does not receive illumination of the light beam L, and thus, the surface electric potential of the corresponding surface region remains as the electric potential (that is, the second electric potential) which is adjusted by the previously performed secondary charging process. Further, an electric potential difference between the corresponding non-exposure region and the conductive blade 4 is small and current flowing therebetween (blade current) is small as well. Accordingly, deterioration of the photosensitive body 2 or deterioration of the conductive blade 4 may be effectively prevented, thereby lengthening the life span of the apparatus. Especially, in the case of a black-and-white printing in which the average printing duty is low, that is, the non-exposure region is relatively wide, the above described effects are noticeable and effective. Thus, the invention may be effectively applied to the black-and-white image forming apparatus in which a single color printing is mainly performed.

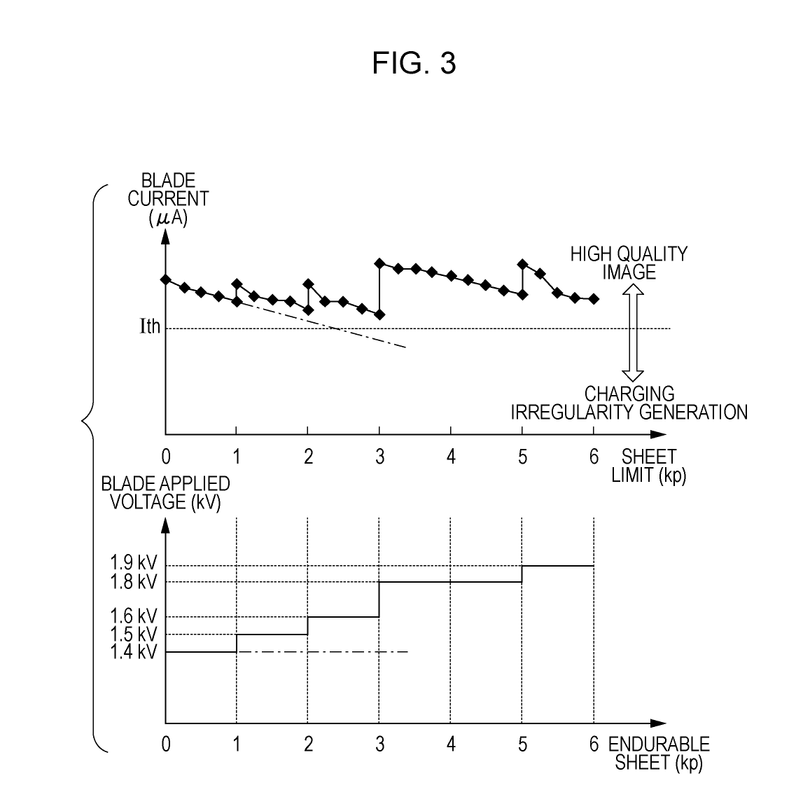

If the aging of the conductive blade 4 occurs as the accumulated operation time or the number of accumulated printing sheets becomes increased, as shown in FIG. 3, charging irregularity may be generated. For example, it has been discovered that if the printing sheets are accumulated in a state that the cleaning and charging bias Vbd of the direct current voltage of −1.4 kV is applied to the conductive blade 4, high quality images may be formed in a limit of about 2000 sheets or less; however, if the accumulated printing sheets exceed 2000, the blade current flowing between the conductive blade 4 and the photosensitive body 2 is decreased as indicated by a dashed-dotted line in FIG. 3, and the charging irregularities are generated on the surface of the photosensitive body 2, thereby deteriorating the image quality. That is, in order to desirably charge the surface of the photosensitive body 2, the blade current needs to be maintained at a predetermined value Ith (for example, 25 μA) or more. Accordingly, in this embodiment, whenever the number of the accumulated printing sheets becomes 1000, 2000, 3000 or 5000, the direct current voltage (blade applied voltage) to be applied to the conductive blade 4 is increased with a step shape. Thus, the blade current flowing between the conductive blade 4 and the surface of the photosensitive body 2 is constantly maintained at the predetermined value Ith or more, thereby desirably charging the surface of the photosensitive body 2.

As described above, according to the embodiment, the toner is cleaning-removed from the surface of the photosensitive body 2 by the conductive blade 4 which is in contact with the surface of the photosensitive body 2 in the cleaning and charging position P1, and the surface of the photosensitive body 2 is primarily charged at the first electric potential. Since the primary charging process and the cleaning process are simultaneously performed by the conductive blade 4 as described above, the charging process and the cleaning process may be performed with a small number of components and miniaturization of the apparatus may be achieved. In addition, since the direct current voltage (blade applied voltage) having the same polarity as the normal charged polarity of the toner is applied to the conductive blade 4 to perform the primary charging of the surface of the photosensitive body 2, as described above in the summary, deterioration of the photosensitive body 2 and an error of the cleaning may be prevented, and simultaneously, the primary charging process and the cleaning process may be desirably performed.

Further, in this embodiment, since the secondary charging is performed by the so-called scorotron charger 5 having positive polarity for the surface of the photosensitive body 2 which is primarily charged, relatively fewer discharge products or ozone are generated. In addition, the life span of the charge wire 5b may be lengthened. In the image forming apparatus 1 with such a configuration, it is not realistic to absolutely prevent discharge products from being generated. Thus, it is desirable to install an exhaust unit which vents the surroundings of the cleaning and charging position P1 and the secondary charging position P2. In addition, it is preferable to enhance exhausting efficiency of the discharge products from the cleaning and charging position P1 and the secondary charging position P2, by installing an airflow generating unit such as a fin which guides airflow in the cleaning and charging position P1 or the secondary charging position P2.

Further, in this embodiment, since the CPU 101 corresponds to a “constant voltage control unit” in the invention and constant-voltage controls direct current voltage to be applied to the conductive blade 4, the neutralization-free configuration may be employed. Thus, the image forming may be performed with a simplified apparatus configuration and high image quality. Moreover, according to the embodiment including the constant voltage control and the neutralization-free configuration, since the blade current flowing between the non-exposure region and the conductive blade 4 in the cleaning and charging position P1 is small, the life span of the apparatus may be lengthened.

Further, since the blade current flowing between the conductive blade 4 and the surface of the photosensitive body 2 is constantly controlled to be maintained above the predetermined value Ith by increasing the blade applied voltage according to the aging of the conductive blade 4. The surface of the photosensitive body 2 may be uniformly and desirably charged over a long period. In this embodiment, the aging of the conductive blade 4 is determined by the accumulated printing sheets, but the timing when the blade applied voltage is increased may be controlled on the basis of any other parameter, for example, accumulated operation time or the number of accumulated revolutions of the photosensitive body 2.

In addition, since this embodiment employs the so-called non-contact developing method in which the toner is provided to the surface of the photosensitive body 2 from the developing roller (toner carrier) 7a which is arranged opposite to the photosensitive body 2 in a non-contact manner, to develop the electrostatic latent image, the following effects occur. That is, the additive detached from the toner inhibits the uniform charging of the surface of the photosensitive body 2. Thus, if the detached additive which is adhered to the developing roller 7a is scattered from the developing roller 7a to adhere to the photosensitive body 2, it is difficult to appropriately charge the surface of the photosensitive body 2, thereby causing deterioration of image quality. However, in this embodiment, since the developing roller 7a is spaced from the photosensitive body 2, it is difficult for the additive adhered to the developing roller 7a which is detached from the toner to be scattered to the photosensitive body 2, thereby preventing the above problems. Further, in order to effectively prevent the scattering of the additive detached from the developing roller 7a, for example, it is desirable that the developing roller 7a is formed of metal. This is because, with such a configuration, an image force of the additive for the developing roller 7a becomes large and squirting of the additive detached from the photosensitive body 2 becomes inhibited.

The invention is not limited to the above described embodiment, and may include a variety of modifications in addition to the above described embodiments without departing the spirit of the invention. For example, in this embodiment, the scorotron charger 5 having the positive polarity is used as the charger 5 which performs the secondary charging, but the charger 5 may employ other chargers such as a non-contact roller charger or a contact roller charger. That is, the charger 5 may employ a charger which is capable of adjusting the surface electric potential of the photosensitive body 2 to the second electric potential by providing the electric charge having the reverse polarity to the normal charged polarity to the surface of the photosensitive body 2 which is primarily charged.

Further, in this embodiment, the direct current voltage to be applied to the conductive blade 4 is constant-voltage-controlled, but the blade current flowing between the conductive blade 4 and the photosensitive body 2 may be constant-current-controlled. Herein, in the case that the constant-current-control is performed, a predetermined current flows between the non-contact region and the conductive blade in the cleaning and charging position P1, and thus, the non-contact region becomes overcharged. In order to prevent this problem, it is preferable to install a neutralization unit between the transfer position P5 and the cleaning and charging position P1.

Moreover, for example, the respective numerical values in the above described embodiment are only exemplary, and thus, the invention is not limited thereto. Further, in this embodiment, the negative charged toner is used, but the invention may be applied to an image forming apparatus which uses a positive charged toner. In this case, an electric potential relation of the respective units may be reversed to the above descried embodiment.

In the above described embodiment, the type of the toner is not particularly described, but in the case of a toner having a small particle diameter, it is desirable to consider the following. That is, recently, in order to achieve high-definition image, high speed processing and low temperature fixing, it is considered that a toner having a particle diameter smaller than before is used. In the small particle diameter toner (for example, having a volume average particle diameter of 5 μm or less and a degree of circularity of 0.95 or more), a part of the toner may pass by the conductive blade 4 to adhere to a blade surface (reference numeral 4a in FIG. 1). Such a problematic phenomenon is not generated in a grinding toner which has been widely used in the related art. However, in the case of the small particle diameter toner, the primary charging becomes unstable in the cleansing and charging position P1 while the cleaning and charging are repeated by the conductive blade 4, thereby causing problems such as reduction in the charging electric potential. In order to solve this problem, it is preferable that the toner includes the additive having a leak function. That is, if the additive having the leak function (hereinafter, referred to as “leak additive”) is included in the toner which is adhered to the conductive blade 4 as described above, even though the toner is adhered on the conductive blade 4 due to a long period of use, an electric charge may be provided on the surface of the photosensitive body 2 through the leak additive, thereby desirably charging the surface of the photosensitive body 2. As a result, it is possible to achieve desirable image forming without charging error over a long period of time. Herein, by using the leak additive having a low isolation ratio, detachment of the leak additive from the toner may be prevented, and thus, the above described effect may be reliably achieved. In addition, an outer diameter of the leak additive may be set to be larger than that of an insulating additive included in the toner, and thus, the primary charging may be more stabilized. Titania, an oxide semiconductor (zinc oxide, tin oxide or the like) or inorganic particulates such as silica which are coated by a semi-conductive film such as ATO (obtained by doping antimony to tin oxide) or ITO (obtained by doping indium to tin oxide) on at least part of the surface may be used as the leak additive. Especially, zinc oxide is an example of a leak additive having the low isolation ratio.

Further, the image forming apparatus according to the embodiment exposes the surface of the photosensitive body 2 which is uniformly charged by the exposure unit 6 to form the electrostatic latent image, but may use any latent image forming unit other than the exposure unit as described above, as long as it is capable of forming the electrostatic latent image on the surface of the charged latent image carrier.

Moreover, in this embodiment, the number of the developing units 7 is not particularly specified, but the invention is preferably applicable to a color image forming apparatus in which a plurality of developing units are installed in a rotatable rotary developing unit, a so-called tandem image forming apparatus in which the plurality of developing units are arranged around the intermediate transfer medium, or a black-and-white image forming apparatus in which a black-and-white image is formed by a single developing unit or the like.

The entire disclosure of Japanese Patent Application No.2009-077268, filed Mar. 26, 2009 is expressly incorporated by reference herein.

What is claimed is:

1. An image forming apparatus comprising:
a latent image carrier which circumferentially rotates in a predetermined rotational direction;
a conductive blade which cleans a surface of the latent image carrier by being in contact with the surface of the latent image carrier, and charges the surface of the latent image carrier at a first electric potential having the same polarity as normal charged polarity of a toner according to application of direct current voltage having the same polarity as the normal charged polarity of the toner, in a predetermined cleaning and charging position; and
a charger which provides an electric charge having reverse polarity to the normal charged polarity and adjusts an electric potential of the surface of the latent image carrier to a second electric potential, in a secondary charging position located on a downstream side of the cleaning and charging position in the rotational direction.

2. The image forming apparatus according to claim 1, further comprising a constant voltage control unit which constant-voltage-controls the direct current voltage which is applied to the conductive blade.

3. The image forming apparatus according to claim 2, further comprising a transfer unit which transfers a toner image formed on the surface of the latent image carrier to a transfer medium, in a transfer position located on an upstream side of the cleaning and charging position in the rotational direction,
wherein the conductive blade removes the remaining toner on the surface of the latent image carrier which reaches the cleaning and charging position in a state that the surface of the latent image carrier is not electrically neutralized after passing through the transfer position, and charges the surface of the latent image carrier at the first electric potential.

4. The image forming apparatus according to claim 2, wherein a potential difference between the conductive blade and the surface of the latent image carrier is increased as endurance of the conductive blade is performed.

5. The image forming apparatus according to claim 1, further comprising a constant current control unit which constant-current-controls current flowing between the conductive blade and the surface of the latent image carrier.

6. The image forming apparatus according to claim 1, further comprising:
a transfer unit which transfers a toner image formed on the surface of the latent image carrier to a transfer medium in a transfer position located on an upstream side of the cleaning and charging position in the rotational direction; and
a neutralization unit which electrically neutralizes the surface of the latent image carrier in a neutralization position between the transfer position and the cleaning and charging position in the rotational direction.

7. The image forming apparatus according to claim 1, further comprising:
a latent image forming unit which forms an electrostatic latent image on the surface of the latent image carrier in a latent image forming position located on a downstream side of the secondary charging position in the rotational direction; and
a development unit which provides toner to the surface of the latent image carrier from a toner carrier which is arranged opposite to the latent image carrier in a non-contact manner and develops the electrostatic latent image, in a development position located on a downstream side of the latent image forming position in the rotational direction.

8. The image forming apparatus according to claim 7, wherein the toner carrier is a metal developing roller.

9. An image forming method comprising:
cleaning a surface of a latent image carrier which circumferentially rotates in a predetermined rotational direction by bring a conductive blade into contact with the surface of the latent image carrier, and charging the surface of the latent image carrier at a first electric potential having the same polarity as normal charged polarity of a toner according to application of direct current voltage having the same polarity as the normal charged polarity of the toner to the conductive blade; and providing an electric charge having reverse polarity to the normal charged polarity for the surface of the latent image carrier which is charged at the first electric potential, and adjusting the electric potential of the surface of the latent image carrier to a second electric potential.
